(19) United States
(12) Patent Application Publication
(10) Pub. No.: US 2011/0151179 A1
(43) Pub. Date: Jun. 23, 2011

(54) SEMI-FINISHED PRODUCT AND PREFORM USED TO MANUFACTURE A PART MADE FROM COMPOSITE MATERIAL

(75) Inventors: Nikolaus Bätge, Deisenhofen (DE); Patricia Parlevliet, Munchen (DE); Christian Weimer, Munchen (DE)

(73) Assignee: EUROCOPTER DEUTSCHLAND GMBH, Donauworth (DE)

(21) Appl. No.: 12/972,968

(22) Filed: Dec. 20, 2010

(30) Foreign Application Priority Data
Dec. 22, 2009 (EP) 09 400063.5

(51) Int. Cl. B32B 3/06; D05B 23/00

(52) U.S. Cl. 428/102; 112/402

(57) ABSTRACT

A semi-finished product used to mold a composite part including at least one dry laminar reinforcing layer that is designed to be impregnated with an impregnation matrix by liquid injection/infusion. The semi-finished product includes a thermoplastic layer, at least locally, where the properties of the component materials provide the future molded part, at least locally, with the required properties; since the thermoplastic layer has been stitched to at least one reinforcing layer using at least one yarn crossing through the perforations in said thermoplastic layer and in at least one reinforcing layer.

### CROSS REFERENCE TO RELATED APPLICATION

This application claims the benefit of European patent application no. EP 09 400063.5 filed Dec. 22, 2009, that disclosure is incorporated herein by reference.

### FIELD OF THE INVENTION

This invention pertains to the general technical field of composite material part manufacture, including, for example, reinforcements parts made of matrix impregnated fibers.

### BACKGROUND OF THE INVENTION

Composite material parts may be obtained by molding reinforced composite material strengthened around a molding core. In addition, this composite material, produced using a semi-finished product or preform that is yet to be impregnated, may include pre-impregnated layers, also known as “Prepreg”. Targeted infusion/injection of a dry preform is then completed before a final solidification operation is performed on the part thus produced. By way of example, such parts are for use in the aviation industry, aerospace structures, automotive industry or wind-energy industry.

In the rest of the text, “impregnation matrix” designates any type of polymer resin or polymer resin mixture presenting low viscosity and that is solidified by being polymerized.

The term “fiber” or “fiber” is used below to designate any type of structural fiber such as carbon fiber, glass fiber, aramid fiber, polyethylene (polyolefin), basalt or natural fiber.

Known molding methods are not described in detail herein.

To modify the hardness of composite parts or to ensure their fire resistance, specific resin component mixtures or compounds should be prepared prior to the reinforcing layer (for example, layers of carbon fibers) impregnation operation. These mixes provide the composite parts with the required mechanical and physical properties, and, without them it would be impossible to qualify said parts for various applications.

Integrating these mixes or compounds in a matrix or in an impregnation resin increases its viscosity and leads to poor infiltration of reinforcing layers.

Impregnation matrices that integrate these specific mixes cannot, therefore, be used as infusion matrices in the vacuum injection processes or in RTM processes (Resin Transfer Molding). This is why the components that provide the required mechanical and physical properties are integrated in the preform rather than in an impregnation resin.

A proposal was made to process hardness-related properties and fire resistance-related properties in a different manner and to integrate the corresponding components in fiber-based architectures. These components are generally found in the form of a fiber-based product or a powder that should be added to the preform.

The drawback of such systems is that the powder is only locally integrated in the preform's fiber architecture.

The drawback of integrating a component in the form of fibers is that it is very difficult to accurately define the areas with modified and optimized mechanical or functional properties.

A further drawback of integrating a component in its powder form is that it is sensitive to the so-called wash-out effect (undesired concentration variation through the composite). There is a risk that the powder particles may be entrained with the impregnation matrix and may accumulate in inappropriate areas. As a result, it is not possible to achieve homogeneous distribution of the powder in the preform.

Another drawback is that forming/draping of such preforms usually requires heat.

Another drawback of current draping/preforming processes is that the fiber architecture cannot be controlled/monitored during the forming process.

There are also examples of using a thermoplastic surface, in the form of a film, placed on heat-solidified polymer parts that should be bound together (e.g. document EP 1 423 256). The parts are placed in mutual contact via their thermoplastic surface. The bond between the two parts is then obtained by fusion, followed by solidification of the thermoplastic surfaces. However, using a thermoplastic film in this way—as a means of binding at the interface of two parts—does not necessarily optimize the mechanical and physical properties of a composite part.

The document U.S. Pat. No. 5,334,687 describes a semi-finished product for manufacturing a composite part including at least one dry laminar reinforcing layer which will be impregnated by an impregnation matrix (thermoplastic resin system). The multilayer reinforcing product includes, at least locally, one additional layer or film of the barrier kind preventing a flow of resin through it or an additional decorative layer. The layers are stitched on at least one reinforcing layer by using one yarn which passes through the additional layers and the at least one reinforcing layer. This document however does not disclose that one of the additional layers is a thermoplastic layer.

In this document a thermoplastic flexible web is mentioned, which is something different than a perforated thermoplastic film/foil. In addition, U.S. Pat. No. 5,334,687, applies to a fully thermoplastic composite, which is different than a combined thermoset composite with thermoplastic modifications/phases. In addition, no flow adjustment is mentioned with the aid of the thermoplastic layer. Moreover, this document concerns infusion by molten film impregnation which is different than a liquid resin infusion.

### SUMMARY OF THE INVENTION

This invention concerns the manufacture of semi-finished products such as dry preforms with at least one laminar reinforcing layer; said semi-finished products or preforms are impregnated using an impregnation matrix during injection or infusion operations. The choice of material used to make these preforms, or any material associated with them, influences the mechanical and physical properties of future composite parts.

Consequently, this invention aims to provide a new preform for molding a composite part, without the above-mentioned drawbacks and with a particularly straightforward and inexpensive manufacturing process.

This invention also aims to provide a new preform for molding a composite part, the mechanical and fire-resistant properties of which are optimized simultaneously.

The objectives of the invention are met by a semi-finished product for manufacturing a composite part including at least one dry laminar reinforcing layer designed to be impregnated with an impregnation matrix by liquid injection/infusion, wherein it includes at least locally, as a minimum, one thermoplastic layer where the properties of its component materials provide at least locally the future molded part with at least some of the required properties, wherein said thermoplastic layer is stitched on at least one reinforcing layer using at least one yarn passing through said thermoplastic layer and through at least one reinforcing layer.

In one embodiment of a semi-finished product in accordance with the invention, the thermoplastic layer and the reinforcing layer(s) have perforations through which passes the yarn.

In one embodiment of a semi-finished product in accordance with the invention, the perforations are made with stitching means.

In another embodiment of a semi-finished product in accordance with the invention, the perforations are made with perforation means prior to the stitching operation.

By the way of an example, the thermoplastic layer and the reinforcing layer(s) have at least locally additional perforations and/or slits for enhancing its drapeability.

In an embodiment of a semi-finished product in accordance with the invention, the semi-finished product is shaped to a preform tool/mould, with the help of at least the stitches.

In one embodiment of a semi-finished product in accordance with the invention, the yarn is composed of a thermoplastic material for which the fusion temperature is greater than the fusion temperature of the thermoplastic layer.

In one embodiment of a semi-finished product in accordance with the invention, the fusion temperature of the thermoplastic layer is comprised between room temperature and 400° C., preferably 80° C.-300° C., and the fusion temperature of thermoplastic yarn is comprised between 80° C. and 400° C., preferably between 120° C. and 250° C.

In one embodiment of a semi-finished product in accordance with the invention, the thermoplastic layer is a non-woven layer such as a veil.

In an embodiment of a semi-finished product in accordance with the invention, the yarn is composed of a carbon fiber-based material.

In an embodiment of a semi-finished product in accordance with the invention, the thermoplastic layer is inserted between two reinforcing layers.

In one embodiment of a semi-finished product in accordance with the invention, the thermoplastic layer is positioned on an outer side of an external reinforcing layer of said semi-finished product.

In one embodiment of a semi-finished product in accordance with the invention, the thermoplastic layer includes a least one thermoplastic sheet.

In another embodiment of a semi-finished product in accordance with the invention, the thermoplastic layer includes an assembly of several thermoplastic sheets which are for instance stitched together.

As an example, at least one of the thermoplastic sheets has different structural characteristics and/or properties than the other thermoplastic sheets.

The objectives of the invention are also met using a preform for molding a composite part including at least one laminar reinforcing layer, characterized in that it comprises a semi-finished product that complies with the above description.

The objectives of the invention are also met using a molded and solidified part made from a composite material, including at least one preform that complies with the above description and that is impregnated by using at least one impregnation matrix of the resin prior to its solidification.

An advantage presented by a semi-finished product in accordance with the invention lies in the easy manipulation of the dry thermoplastic sheet during the draping operation of a preform.

Furthermore, the draping configuration of the preform is held in place by using a thermoplastic yarn whose fusion temperature is different than the thermoplastic layer fusion temperature.

The use of a thermoplastic yarn also makes it possible to prepare a semi-finished product or a preform, for the production of complex parts by using the thermoplastic welding technique to bind all the different parts or preforms. In this way a stiffening/shaping element for an external cover surface can be assembled.

Another advantage presented by a semi-finished product in accordance with the invention lies in the fact that there is no need of heat for binding or deep drawing the thermoplastic sheet on its support (e.g. reinforcing layers).

Another advantage obtained by the invention is that the fiber architecture can be controlled through, either the stitching yarn or the thermoplastic film/ sheet, with for example dedicated slits.

Another advantage of the invention is that the thermoplastic film/ sheet can enhance the drapeability of unstable (easily deformable) semi-finished products.

Another advantage presented by a semi-finished product in accordance with the invention lies in the fact that it is very easy to shape it into a particular shape. The thermoplastic layer is relatively stiff. However, the stitches made along a particular path or design through said thermoplastic layer and through at least one reinforcing layer enhance the drapeability of the semi-finished product. This can also be improved with the help of perforations and/or slits.

A better shaping is obtained due to the fact that there remains outside the stitching, large surfaces of contact between the different layers of the semi-finished product which can glide one over another. The preform quality is so improved.

Another advantage presented by a semi-finished product in accordance with the invention lies in its enhanced mechanical properties.

Another advantage presented by a semi-finished product in accordance with the invention lies in the fact that it can be stored at room temperature.

### BRIEF DESCRIPTION OF THE DRAWINGS

More details of the invention and its advantages shall appear in the following description, with a production example provided for use in reference with the appended figures:

FIG. 1, an exploded view of a laminar preform, produced in accordance with the invention, before its assembly,

FIG. 2, an exploded view of another example of a laminar preform, produced in accordance with the invention, during its assembly,

and FIG. 3, an exploded view of a further example of a laminar preform, produced in accordance with invention.

### DETAILED DESCRIPTION OF THE PREFERRED EMBODIMENT

Elements that are structurally or functionally identical, present in several separate figures or illustrations are assigned a single numerical or alphanumerical reference.

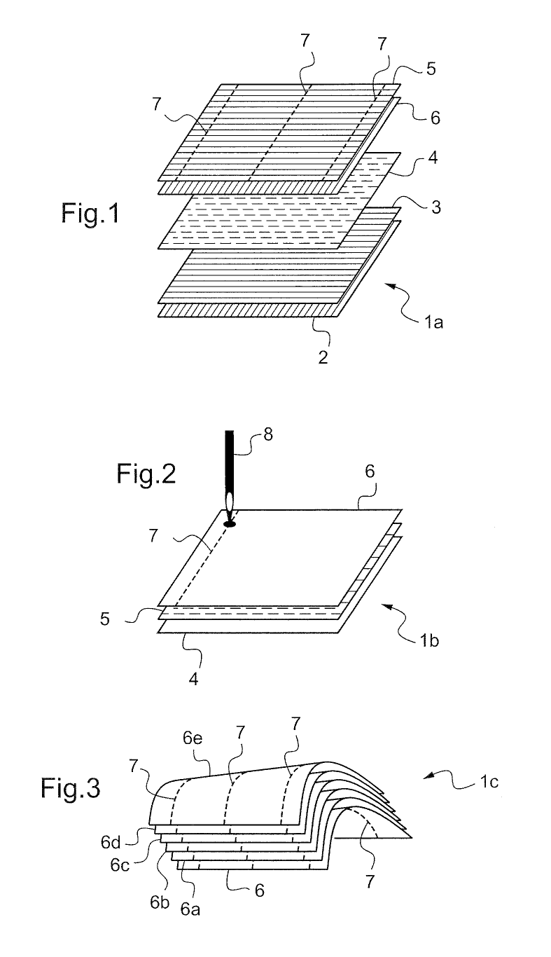

FIG. 1 illustrates an example of semi-finished product or a preform 1a produced in accordance with the invention. Semi-finished product or perform 1a, represented in an exploded view, includes the assembly of reinforcing layers 2, 3, 4 and 5 and a thermoplastic layer 6 in the form of a thermoplastic sheet.

The thermoplastic layer 6 is favorably inserted between reinforcing layers 4 and 5 before being stitched on layer 5 using a yarn 7.

As a variant, thermoplastic layer 6, as well as reinforcing layers 4, 5 may be closely bound by a stitching operation. An assembly with more reinforcing layers 2, 3, 5, and 5 and/or thermoplastic layers 6 may also be envisaged to produce a preform in accordance with invention.

Corresponding perforations, not shown, are made in the layers that have been stitched together.

FIG. 2 illustrates an example of another preform 1b produced in accordance with the invention. Preform 1b, represented in an exploded view, includes the assembly of reinforcing layers 4 and 5 and a thermoplastic layer 6 in the form of a thermoplastic sheet.

The thermoplastic layer 6 is positioned on an external side of preform 1b, to then be stitched along one 5 at least of the reinforcing layers 4 and 5 by using yarn 7.

A needle 8 from a stitching device not shown is used to produce the perforations required for the passage of a yarn 7. Such a stitching device is known and shall not be described in more detail.

FIG. 3 illustrates an example of a part of preform 1c, produced in accordance with the invention. The part of preform 1c, represented in an exploded view, includes the assembly of thermoplastic layers 6, 6a, 6b, 6c, 6d and 6e. The example shown is an assembly of thermoplastic sheets bound together using a yarn 7. This assembly of thermoplastic sheets is designed to compose part of the draping of another part of a preform (not shown) or to compose a thermoplastic layer 6 presenting specific properties.

In an example of a preform produced in accordance with the invention, yarn 7 is composed of a thermoplastic material, with a fusion temperature that is greater than the fusion temperature of thermoplastic layer 6.

The fusion temperature of thermoplastic layer 6 is, for example, comprised between room temperature and 400° C., preferably between 80° C. and 300° C., and the fusion temperature of the thermoplastic yarn 7 is, for example, comprised between 80° C. and 400° C. and preferably between 120° C. and 250° C.

In another example of a preform in accordance with the invention, the yarn is composed of carbon fiber-based materials, polyester, polyethylene, etc . . .

In another example of a preform in accordance with the invention, the thermoplastic layer 6 includes an assembly of several thermoplastic sheets stitched together.

As an example, one of the thermoplastic sheets has different structural characteristics and/or properties than the other thermoplastic sheets.

In an example of a preform in accordance with the invention, at least one of the materials of which the thermoplastic layer 6 is made, which provides the future molded part with its fire-resistance properties such as flame retardancy.

In an example of a preform in accordance with the invention, at least one of the materials of which the thermoplastic layer is made, which provides the future molded part with its required toughness level

Naturally, the present invention may be subjected to numerous variations as to its implementation. Although several implementations are described above, it will readily be understood that it is not conceivable to identify exhaustively all possible implementations. It is naturally possible to envisage replacing any of the means described or any of the steps described by equivalent means or equivalent steps without going beyond the scope of the present invention.

1. A semi-finished product for manufacturing a composite part including at least one dry laminar reinforcing layer to be impregnated with an impregnation matrix by liquid injection/infusion,
including at least locally, as a minimum, one thermoplastic layer where the properties of its component materials provide at least locally the future molded part with at least some of the required properties,
the thermoplastic layer being stitched on at least one reinforcing layer using at least one yarn passing through said thermoplastic layer and through at least one reinforcing layer.

2. The semi-finished product according to claim 1, wherein the thermoplastic layer and the reinforcing layer(s) have perforations through which passes the yarn.

3. The semi-finished product according to claim 2, wherein the perforations are made with stitching means.

4. The semi-finished product according to claim 2, wherein the perforations are made with perforation means prior to the stitching operation.

5. The semi-finished product according to claim 2, wherein the thermoplastic layer and the reinforcing layer(s) have at least locally additional perforations and/or slits for enhancing its drapeability.

6. The semi-finished product according to claim 1, wherein the product is shaped to a perform tool/mould with the help of at least the stitches.

7. The semi-finished product according to claim 1, wherein the at least one yarn is composed of a thermoplastic material for which the fusion temperature is greater than the fusion temperature of the thermoplastic layer.

8. The semi-finished product according to claim 7, wherein the fusion temperature of the thermoplastic layer is between room temperature and 400° C., preferably between 80° C. and 300° C. and the fusion temperature of thermoplastic yarn is between 80° C. and 400° C., preferably between 120° C. and 250° C.

9. The semi-finished product according to claim 7, wherein the at least one yarn is composed of a carbon fiber-based material.

10. The semi-finished product according to claim 1, wherein the thermoplastic layer is inserted between two of the at least one reinforcing layers.

11. Semi-finished product according to claim 1, wherein the thermoplastic layer is positioned on the outer side of an external reinforcing layer of said semi-finished product.

12. The semi-finished product according to claim 1, wherein the thermoplastic layer comprises at least one thermoplastic sheet/film.

13. The semi-finished product according to claim 1, wherein the thermoplastic layer comprises an assembly of several thermoplastic sheets/films that are stitched together.

14. The semi-finished product according to claim 13, wherein at least one of the thermoplastic sheets/films has different structural characteristics and/or properties than the other thermoplastic sheets/films.

15. The semi-finished product according to claim 1, wherein the thermoplastic layer is a non-woven layer such as a veil.

16. A preform for molding a composite part including at least one laminar reinforcing layer, wherein the composite part comprises a semi-finished product according to claim 1.

17. A molded and solidified part made from composite material including at least one preform according to claim 16, that is impregnated with at least one impregnation resin matrix prior its solidification.
